(19) United States
(12) Patent Application Publication
(10) Pub. No.: US 2010/0233371 A1
(43) Pub. Date: Sep. 16, 2010

(54) POLYTETRAFLUOROETHYLENE COATING AGENT, METHOD OF PREPARATION AND USE

(75) Inventors: Yool Koo Kim, Gyeonggi-do (KR); In Ki Hwang, Gyeonggi-do (KR); Sung Moon Choi, Gyeonggi-do (KR); In Woong Lyo, Gyeonggi-do (KR); Seung Gyun Ahn, Seoul (KR); Joong Soo Kim, Gyeonggi-do (KR); Dae Soon Lim, Seoul (KR); Joon Sung Park, Seoul (KR)

Correspondence Address: EDWARDS ANGELL PALMER & DODGE LLP, P.O. BOX 55874, BOSTON, MA, 02205, US

(73) Assignees: HYUNDAI MOTOR COMPANY, Seoul (KR); KIA MOTORS CORPORATION, Seoul (KR); KOREA UNIVERSITY RESEARCH AND BUSINESS FOUNDATION, Seongbuk-gu (KR)

(21) Appl. No.: 12/565,235

(22) Filed: Sep. 23, 2009

(30) Foreign Application Priority Data
Mar. 13, 2009 (KR) 10-2009-0021770

(51) Int. Cl. B05D 3/12; C08F 8/00; B05D 3/02

(52) U.S. Cl. 427/290; 525/104

(57) ABSTRACT

Disclosed is a polytetrafluoroethylene coating agent having low friction and high wear resistance, obtained by dispersing nanodiamond powder in a polar organic solvent, stirring the nanodiamond dispersion solution and a silane coupling agent, and stirring the silane-treated dispersion solution and an oily polytetrafluoroethylene coating solution, in which the silane coupling agent has at least one organic functional group selected from, but not limited to, a mercapto group and an amino group, the organic functional group exhibiting high bondability to polytetrafluoroethylene. A method of preparing the polytetrafluoroethylene coating agent and a method of using the polytetrafluoroethylene coating agent are also provided.

### CROSS-REFERENCE TO RELATED APPLICATIONS

This application claims under 35 U.S.C. §119(a) priority to Korean Application No. 10-2009-0021770, filed on Mar. 13, 2009, the disclosure of which is incorporated herein by reference in its entirety.

### BACKGROUND OF THE INVENTION

1. Field of the Invention

The present invention relates, in general, to a polytetrafluoroethylene (PTFE) coating agent that preferably includes a nanodiamond, a method of preparing the same, and a method of using the same.

2. Description of the Related Art

A nanodiamond is diamond crystal that is suitably micronized to a nanometer size range. Preferred applications may include coating and polishing agents for the hardening of the surface of metal and for the prevention of the wear and corrosion of metal.

Preferably, a nanodiamond can be prepared through a high-temperature high-pressure method, a synthesis method using shock waves, a chemical vapor deposition (CVD) method, a detonation method, etc. For example, the detonation method entails detonating gunpowder in an inert atmosphere so that carbon atoms remaining after incomplete combustion are suitably grown into diamond crystals having a particle size of 4.3±0.4 nm.

Preferably, individual particles of actually commercially available nanodiamond powder are present in the form of an aggregate having a diameter ranging from hundreds of nm to ones of μm. In particular, because a nanodiamond has a very large surface area per volume, its surface energy is considerably large. Upon production through detonation, a nanodiamond is present not in the form of unit particles having a size on a nanometer scale, but in the form of an aggregate of unit particles, called a hard aggregate, which makes it very difficult to physically separate the particles.

For this reason, techniques for using nanodiamond powder depend considerably on how the aggregate of diamond particles is suitably milled and uniformly dispersed. Conventionally, nanodiamond powder is suitably dispersed in an organic solvent through bead milling, and then suitably treated with a silane coupling agent. Preferably, the silane coupling agent, and in particular, its inorganic functional group, suitably encloses the nanodiamond particles, so that the nanodiamond particles do not aggregate but instead are suitably dispersed in a nano size.

PTFE is utilized as a coating or lubricating agent in the industrial field because of its excellent low-friction properties. As a conventional PTFE coating agent resulting from mixing the dispersion solution of the nanodiamond powder subjected to silane treatment as above with a commercially available PTFE coating solution, a coating agent for use in a piston skirt of a vehicle engine is disclosed in Korean Unexamined Patent Publication No. 2008-0093625, incorporated by reference in its entirety herein, in which the silane coupling agent preferably has an epoxy group as an organic functional group.

Korean Unexamined Patent Publication No. 2008-0093625 is directed to an improved dispersibility of the nanodiamond powder using the silane coupling agent. Korean Unexamined Patent Publication No. 2008-0093625 is not directed to further improvement both in wear resistance and low friction of the PTFE coating agent. For example, Korean Unexamined Patent Publication No. 2008-0093625 does not teach or suggest enhancing bondability between the nanodiamond and the PTFE using a silane coupling agent. Further, Korean Unexamined Patent Publication No. 2008-0093625 does not teach that a coupling reaction between the epoxy group of the silane coupling agent and the PTFE will sufficiently occur under the above preparation conditions of the PTFE coating agent is omitted.

The above information disclosed in this the Background section is only for enhancement of understanding of the background of the invention and therefore it may contain information that does not form the prior art that is already known in this country to a person of ordinary skill in the art.

### SUMMARY OF THE INVENTION

Accordingly, the present invention provides a method of preparing a PTFE coating agent having suitably low friction and suitably high wear resistance by enhancing dispersibility of nanodiamond powder by enhancing bondability between nanodiamond particles and PTFE. The present invention also features a PTFE coating agent that is suitably prepared through the method and a method of using the PTFE coating agent.

Preferred embodiments of the present invention provide a PTFE coating agent, including, but not only limited to, nanodiamond particles, a polar organic solvent in which the nanodiamond particles are suitably dispersed, PTFE mixed with the polar organic solvent in which the nanodiamond particles are suitably dispersed, and a silane coupling agent having an inorganic functional group suitably coupled with the PTFE and an organic functional group suitably coupled with the nanodiamond particles, so as to form a bond between the nanodiamond particles and the PTFE, where preferably the organic functional group has at least one selected from, but not limited to, a mercapto group and an amino group.

In another embodiment, the present invention provides a method of preparing the PTFE coating agent, where the method preferably includes dispersing nanodiamond powder in a polar organic solvent and thus obtaining a dispersion solution, mixing the dispersion solution with a silane coupling agent having at least one organic functional group selected from among a mercapto group and an amino group thus obtaining a silane-treated solution, and mixing the silane-treated solution with an oily PTFE coating solution.

Preferably, the polar organic solvent may suitably include N-methylpyrrolidone.

Preferably, in dispersing the nanodiamond powder, the nanodiamond powder may suitably be mixed with the polar organic solvent and then suitably milled using beads having a diameter of 0.1˜0.3 mm.

Preferably, in dispersing the nanodiamond powder, the nanodiamond powder may be dispersed in an amount of 5˜15 parts by weight based on 100 parts by weight of the polar organic solvent.

Preferably, in mixing the dispersion solution, the silane coupling agent may be suitably mixed in an amount of 0.8˜1.2 parts by weight based on 100 parts by weight of the nanodiamond powder.

Preferably, in mixing the dispersion solution, the dispersion solution and the silane coupling agent may be stirred at 60˜70° C. for 5˜7 hours.

Another further embodiment of the present invention provides a method of using the PTFE coating agent, including roughening a surface of a part, applying the PTFE coating agent on the surface of the part, and subjecting the PTFE coating agent applied on the surface of the part to natural drying or hot air drying and then to thermal treatment at 200˜220° C. for 10˜20 min.

Preferably, the PTFE coating agent may have a viscosity of 25,000˜35,000 cps so as to be screen printed on the surface of the part, and the surface of the part may preferably be subjected to alkali etching before screen printing.

In certain embodiments, the PTFE coating agent may have a viscosity of 50˜100 cps so as to be suitably spray coated on the surface of the part, and the surface of the part may be subjected to sand blasting before spray coating.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not limitative of the present invention, and wherein:

FIG. 1 is a graph showing results of FT-IR (Fourier Transform Infrared) analysis of nanodiamond particles before and after silane treatment;

FIGS. 2A and 2B are schematic diagrams showing the PTFE coating agents of examples of the present invention;

FIG. 2C is a schematic diagram showing the PTFE coating agent of a comparative example;

FIGS. 3A and 3B are scanning electron microscope (SEM) images showing coating films of the PTFE coating agents of the example and comparative example, respectively;

FIGS. 4A and 4B are optical microscope images showing the PTFE coatings of the examples of the present invention after a wear test;

FIG. 4C is an optical microscope image showing the PTFE coating of the comparative example after a wear test;

FIG. 5 is a graph showing results of measuring the coefficient of friction (COF) of the PTFE coatings of the examples and comparative example;

FIG. 6 is a graph showing results of measuring the specific wear rate of the PTFE coatings of the examples and comparative example;

FIG. 7 is a graph showing changes in width of wear track of the PTFE coatings of the examples and comparative example depending on load;

FIGS. 8A and 8B are graphs showing changes in contact resistance and COF of the PTFE coatings of the examples of the present invention;

FIG. 8C is a graph showing changes in contact resistance and COF of the PTFE coating of the comparative example; and

FIG. 9 is a schematic view showing the PTFE coating according to the present invention.

### DESCRIPTION OF SPECIFIC EMBODIMENTS

In one aspect, the present invention features a polytetrafluoroethylene coating agent, comprising nanodiamond particles, a polar organic solvent, polytetrafluoroethylene; and a silane coupling agent.

In one embodiment, the nanodiamond particles are dispersed in the polar organic solvent.

In another embodiment, the polytetrafluoroethylene is mixed with the polar organic solvent in which the nanodiamond particles are dispersed.

In another further embodiment, the silane coupling agent has an inorganic functional group coupled with the polytetrafluoroethylene and an organic functional group coupled with the nanodiamond particles, so as to form a bond between the nanodiamond particles and the polytetrafluoroethylene.

In still another embodiment, the organic functional group has at least one group selected from a mercapto group or an amino group.

In another aspect, the invention features a method of preparing a polytetrafluoroethylene coating agent, comprising dispersing nanodiamond powder in a polar organic solvent, thus obtaining a dispersion solution, mixing the dispersion solution with a silane coupling agent, thus obtaining a silane-treated solution, and mixing the silane-treated solution with an oily polytetrafluoroethylene coating solution.

In one embodiment, the silane coupling agent has at least one organic functional group selected from a mercapto group and an amino group.

Hereinafter, a detailed description is provided of the present invention.

According to preferred embodiments of the present invention, a PTFE coating agent is preferably constructed such that nanodiamond particles are suitably dispersed in a polar organic solvent, and nanodiamond particles are suitably coupled with PTFE by a silane coupling agent having at least one organic functional group selected from, but not limited to, a mercapto group and an amino group. Preferably, the organic functional group of the silane coupling agent, for example, the amino group, is suitably coupled with PTFE, and the inorganic functional group thereof, for example, a methoxy group is suitably coupled with the nanodiamond particles.

Additionally, according to the present invention, a preferred method of preparing the PTFE coating agent is specified below. Preferably, the PTFE coating agent is suitably prepared through the above method is preferably included in the scope of the present invention.

The present invention features, in preferred embodiments, dispersion of a nanodiamond. According to preferred embodiments of the present invention, nanodiamond powder is suitably dispersed in the polar organic solvent. Preferably, as the nanodiamond powder, powder having a particle size distribution of 10100 nm is used. A preferred example of the polar organic solvent includes, but is not only limited to, N-methylpyrrolidone (NMP). Preferably, NMP is compatible with a PTFE coating solution and has a suitably high boiling point (204° C.) and is thus not easily volatilized in the course of bead milling as described below. According to other further embodiments, NMP is neither scattered nor ignited at 60˜70° C. which is the preferred silane treatment temperature, and thus, according to certain preferred embodiments, NMP is preferable to the other polar organic solvents.

According to preferred exemplary embodiments of the present invention, the nanodiamond powder is suitably dispersed in the polar organic solvent through bead milling. Preferably, the nanodiamond powder is suitably added in an amount of 5˜15 parts by weight based on 100 parts by weight of the polar organic solvent. According to further related embodiments, if the amount of the nanodiamond powder is suitably smaller than 5 parts by weight based on 100 parts by weight of the polar organic solvent, milling efficiency is suitably low. In other embodiments of the present invention, if the amount of the nanodiamond powder suitably exceeds 15 parts by weight, the nanodiamond powder is suitably difficult to separate from the beads after the milling process, which according to exemplary embodiments is attributable to an increase in viscosity, and thus loss thereof is undesirably increased.

Preferably, the diameter of the beads used for the milling process may be between 0.1˜0.3 mm. According to certain preferred embodiment, if the diameter of the beads is suitably smaller than 0.1 mm, milling efficiency is good but the powder is suitably difficult to separate after the milling process, which may result in increased powder loss. In contrast, according to other preferred embodiments, if the diameter thereof suitably exceeds 0.5 mm, milling efficiency is suitably decreased, thus making it very difficult to obtain the nano-sized particles. Preferably, the material for the beads is not particularly limited, and may include for example zirconia beads, but is not limited as such.

Silane treatment, according to preferred embodiments of the present invention, is described herein. Preferably, the nanodiamond dispersion solution suitably obtained through bead milling, for example as described above, is subjected to silane treatment. Preferably, this silane treatment is performed in a manner such that the dispersion solution is suitably mixed with 0.8˜1.2 parts by weight of the silane coupling agent based on 100 parts by weight of the nanodiamond powder, and the resultant mixture solution is then suitably stirred at 60˜70° C. for 5˜7 hours.

Preferably, the amount of added silane coupling agent is mainly governed by the surface area depending on the particle size of the nanodiamond powder. According to certain preferred embodiments, the use of the silane coupling agent in an amount in the range of 0.8˜1.2 parts by weight based on 100 parts by weight of the nanodiamond powder is suitably adapted for formation of a monolayer on suitably all or almost all of the nanodiamond particles. Preferably, if the amount of the silane coupling agent thereof is smaller than 0.8 parts by weight, a monolayer is not formed on all the nanodiamond particles. In other embodiments, however, if the amount of the silane coupling agent thereof is greater than 1.2 parts by weight, an excess of silane may remain.

According to further preferred embodiments of the present invention, the reason why the silane treatment temperature is preferably maintained at 60˜70° C. is to suitably induce hydrolysis of the silane coupling agent so as to effectively enclose the nanodiamond particles. Preferably, if the treatment temperature is lower than 60° C., reactivity is suitably low. According to other embodiments, if the treatment temperature is higher than 70° C., volatility of the polar organic solvent is increased. According to further embodiments of the present invention, if the stirring time is shorter than 5 hours, insufficient hydrolysis takes place. According to other preferred embodiments, if the stirring time is longer than 7 hours, an excess of the polar organic solvent is suitably volatilized and thus the content ratio of the nanodiamond powder to the polar organic solvent considerably varies. Accordingly, in certain preferred embodiments, the stirring time is suitably set to 6 hours.

According to further preferred embodiments of the present invention, the silane coupling agent has at least one organic functional group selected from, but not limited to, a mercapto group and an amino group. According to other preferred embodiments, examples include, but are not limited only to, aminopropyltrimethoxysilane (ATS), and mercaptotrimethoxysilane (MTS). Preferably, the silane coupling agent has as an inorganic functional group a methoxy group having a suitably high bondability to the nanodiamond particles, so that the hydrophilic surface of the nanodiamond particles is made lipophilic, thus suitably increasing dispersibility. Preferably, the organic functional group is coupled with PTFE, thus enhancing wear resistance.

As described in further preferred embodiments of the present invention, ATS is considered not only to suitably increase dispersibility of the nanodiamond powder but also to suitably maximize bondability to PTFE because the non-shared electron pair present in the N—H bond of the amino group of ATS exhibits suitably high bondability to PTFE. in further related embodiments, MTS enhances dispersibility of the nanodiamond powder and bondability to PTFE.

In preferred exemplary embodiments, the present invention features mixing with an oily PTFE coating solution. Preferably, the silane-treated nanodiamond dispersion solution obtained through silane treatment as above is suitably mixed with an oily PTFE coating solution, thus preparing a PTFE coating agent. In further preferred embodiments, the silane-treated dispersion solution is suitably mixed at a weight ratio of 1:9.9˜1:1.9 with the oily PTFE coating solution which is commercially available. According to other preferred embodiments, if the weight ratio is suitably less than 1:9.9, the amount of nanodiamond is insufficient, thus reducing the effect of enhancing the wear resistance. In other embodiments, if the weight ratio suitably exceeds 1:1.9, the fraction of the polar organic solvent is excessively increased, and the viscosity is remarkably decreased.

A method of using the PTFE coating agent is described below according to certain preferred embodiments of the present invention.

Preferably, before application of the PTFE coating agent on a part, the viscosity of the PTFE coating agent is suitably adjusted to be adapted for a coating process using an organic solvent, in particular embodiments, the polar organic solvent used for the preparation of the coating agent.

In certain exemplary embodiments, for example in the case where the PTFE coating agent is suitably applied through screen printing on a piston skirt of an engine, the viscosity of the PTFE coating agent is suitably adjusted to 25,000˜35,000 cps. According to related embodiments, if the viscosity of the PTFE coating agent is suitably less than 25,000 cps, it is difficult to obtain a sufficient coating thickness. In other embodiments, if the viscosity thereof is greater than 35,000 cps, coating meshes may suitably clog up.

Preferably, the piston skirt is subjected to alkali etching before performing the coating process. According to certain preferred embodiments, alkali etching is suitably performed using sodium hydroxide (NaOH), and according to further preferred embodiments is preferably conducted in a manner such that etching is suitably performed for 9˜11 sec using a 10 wt % sodium hydroxide solution and then ultrasonic washing is suitably performed for 50˜70 sec using a 50 wt % nitric acid (HNO₃) solution. Preferably, through such alkali etching, the surface of the part to be coated is roughened, thus increasing a force of adhesion between the PTFE coating agent and the surface of the piston skirt. According to other embodiments of the present invention, if the etching time is shorter than 9 sec, etching is not sufficiently carried out, thus making it suitably impossible to obtain a desired surface roughness. In other embodiments, if the etching time is suitably longer than 11 sec, etching is excessively performed, thus deteriorating the coating surface properties after the coating process. In preferred embodiments, the mesh size suitable for screen printing is about 150˜180 mesh.

In further exemplary embodiments, in the case where the PTFE coating agent is suitably applied through spray coating on a metal bearing, the viscosity of the PTFE coating agent is suitably adjusted to 50˜100 cps. Preferably, if the viscosity of the coating agent is, for example, less than 50 cps, the coating agent flows down before it is cured, and thus a uniform coating cannot be suitably obtained. In contrast, if the viscosity of the coating agent is greater than 100 cps, the spray nozzle may easily clog up. Accordingly, in preferred embodiments, in order to increase the force of adhesion of the PTFE coating agent, the surface of the metal bearing is suitably processed to have a predetermined roughness through sand blasting before conducting the spray coating process.

Preferably, the piston or metal bearing thus coated is naturally dried or dried using hot air, thus suitably stabilizing the coating surface thereof, after which burning at 180˜240° C. for 10˜20 min, namely, thermal treatment curing is performed. Preferably, if the thermal treatment temperature is suitably lower than 200° C., the curing of the PTFE coating is not sufficient, resulting in poor wear resistance. In contrast, if the thermal treatment temperature is suitably higher than 240° C., thermal deformation of base metal for the piston or metal bearing may result.

Preferred embodiments of the present invention are described in the following examples which are related to measuring the low friction and wear resistance of the PTFE coating agent with reference to the appended drawings, which are set forth to illustrate, but are not to be construed as limiting the present invention.

### Example 1

10 wt % of nanodiamond powder was added to NMP, and then suitably milled with zirconia beads having a diameter of 0.3 mm for 6 hours, thus preparing a nanodiamond dispersion solution, after which the dispersion solution was mixed with 1 wt % of 3-aminopropyltrimethoxysilane (ATS) based on weight of the nanodiamond powder and then the resultant mixture was stirred at 60˜70° C. for 6 hours.

In order to add 1 wt % of the nanodiamond powder based on solid content of a commercially available oily PTFE coating solution (TC-9109-04, available from DAIKIN), the silane-treated dispersion solution was preferably added to the oily PTFE coating solution and homogeneously mixed using a paste mixer, thus suitably preparing a PTFE coating agent having a viscosity adjusted to 30,000 cps using NMP.

In preferred embodiments, the oily PTFE coating solution is a mixture solution of NMP, polyamideimide (PAI) and PTFE. Accordingly, the solid content indicates the amount of material in a gel state of PAI+PTFE. In further specific examples, NMP:(PAI+PTFE) were mixed at a ratio of 60 g:40 g based on 100 g of the PTFE coating solution, and PAI and PTFE were contained at a ratio of 2:1. Preferably, the nanodiamond powder was used in an amount of 0.4 g corresponding to 1% of the solid content of 40 g.

Accordingly, the PTFE coating agent thus prepared was suitably screen printed on a piston skirt made of an aluminum alloy. Preferably, the piston skirt thus coated was primarily dried using hot air, and then maintained at 210° C. for 15 min and air cooled, thus burning it. Accordingly, in further exemplary embodiments, as a result, a uniform and flat PTFE coating that preferably has a thickness of 8˜10 μm and a surface roughness Ra of 0.20 μm was suitably obtained.

### Example 2

In a second example of the present invention, a PTFE coating agent was suitably prepared in the same manner as in Example 1, with the exception that MTS was preferably used as the silane coupling agent, in lieu of ATS.

### Comparative Example 1

In certain exemplary embodiments, a PTFE coating agent was suitably prepared in the same manner as in Example 1, with the exception that 3-glycidoxypropyl trimethoxysilane (GTS) was used as the silane coupling agent, in lieu of ATS.

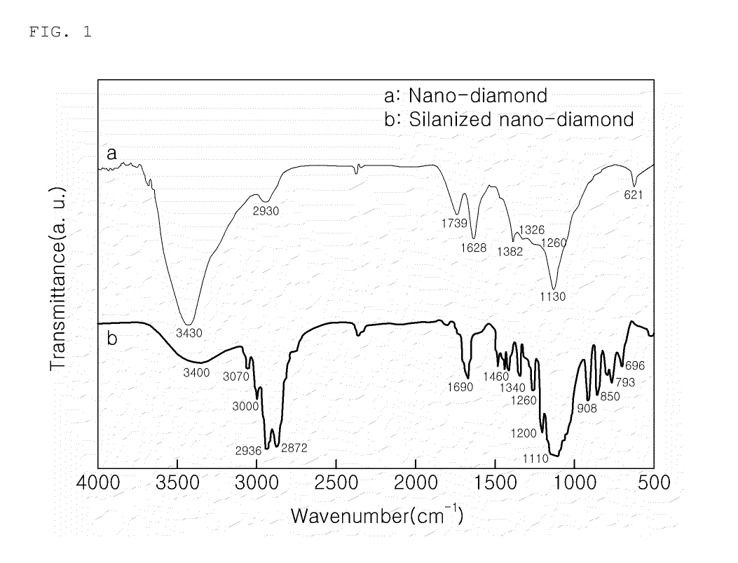

According to certain exemplary embodiments, FIG. 1 shows results of FT-IR analysis of the nanodiamond particles before and after silane treatment, during the preparation process of Example 1.

As shown in FIG. 1, when the surface of the nanodiamond particles is not subjected to silane treatment, the OH group was very conspicuous at a wavenumber of 3430 Cm⁻¹. This is considered to be because the OH group is formed in the course of purification of the nanodiamond powder using moisture or strong acid adsorbed in the air. Furthermore, according to the examples as described herein, asymmetric stretching and vibration of fatty ether (C—O—C) and alkyl-aryl ether (═C—O—C or ═C—O) were respectively showed at wavenumbers of 1130 and 1260 cm⁻¹. Further, the amino-carbonyl group, for example, produced in the course of the detonation of explosive materials containing a carboxyl group, alkane and nitrogen was present on the surface of the nanodiamond particles.

In another preferred embodiment of the present invention, for example as shown in FIG. 1, the silane-treated nanodiamond particles have a suitably more complicated shape. In certain preferred embodiments, this is considered to be due to silane suitably attached to the surface of the nanodiamond particles and secondary byproducts produced during the silane treatment reaction. Preferably, the OH stretching that was seen in the nanodiamond particles not subjected to silane treatment was suitably weakened and became suitably broad after silane treatment. Further, the peaks by the methylene group positioned at the organic backbone of the silane molecule were suitably conspicuous at wavenumbers of 2936 and 2872 cm⁻¹. Accordingly, silane could be confirmed to be firmly adhered through a main reaction between OH groups of the surface of the nanodiamond particles and the methoxy group (−OCH₃) of the silane.

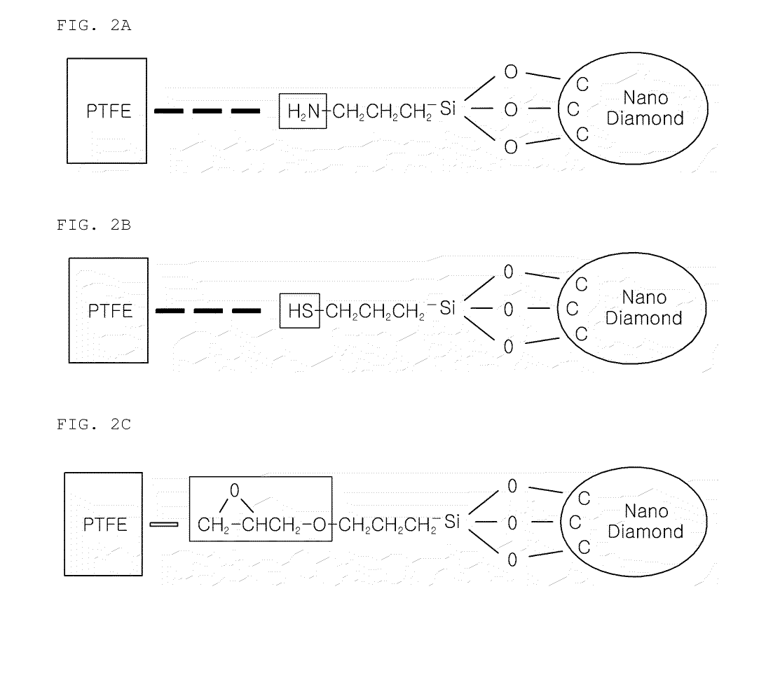

According to other further embodiments of the invention and as shown in FIG. 2, FIGS. 2A to 2C are schematic diagrams showing the PTFE coating agents of Examples 1 and 2 and Comparative Example 1, respectively. Preferably, the PTFE coating agents of Examples 1 and 2 had stronger bondability between the PTFE and the organic functional group than that with the PTFE coating agent of Comparative Example 1.

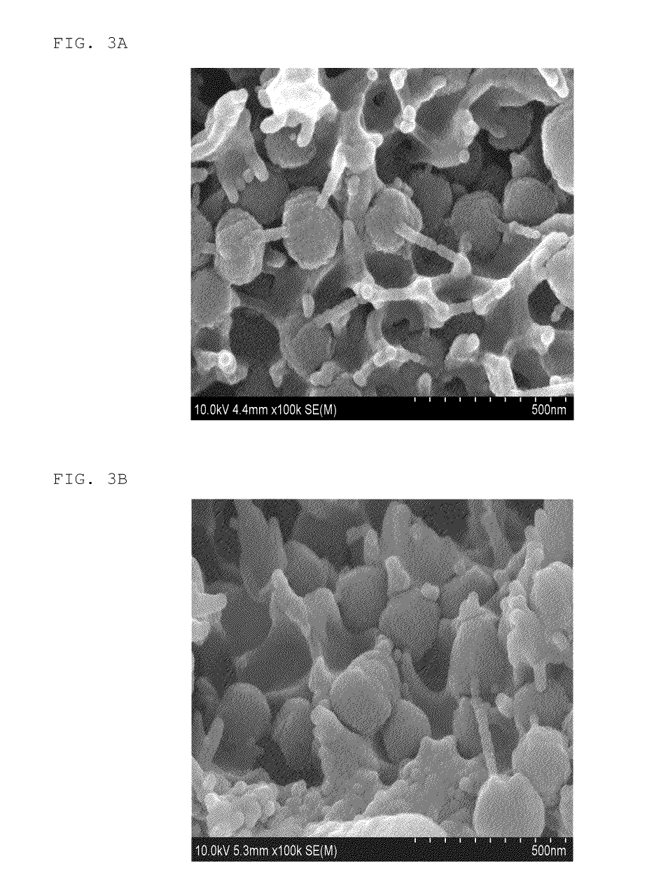

According to other further embodiments of the invention and as shown in FIG. 3, FIGS. 3A and 3B are SEM images of the coating films of the PTFE coating agents of Example 1 and Comparative Example 1, respectively. Preferably, the ATS-treated PTFE coating (FIG. 3A) can be seen to have stronger bondability between the nanodiamond and the PTFE and higher dispersibility of the nanodiamond than those of the GTS-treated PTFE coating (FIG. 3B).

According to preferred exemplary embodiments of the present invention, the coating agents of Examples 1 and 2 and Comparative Example 1, the commercially available PTFE coating solution, and the bead-milled nanodiamond dispersion solution without silane treatment were suitably applied on various test samples, after which the respective test samples were subjected to a suitable wear test using a ball-on-plate type wear tester. Preferably, the wear test was suitably carried out in a manner such that steel bearing balls having a diameter of 12.75 mm were reciprocally moved for 30 min on the surface of each of the test samples coated with the above coating agents. Preferably, the test conditions were a reciprocal movement distance of 22 mm, a movement speed of 2.5 mm/sec, load of 6.86 N, a room temperature and humidity of 40%.

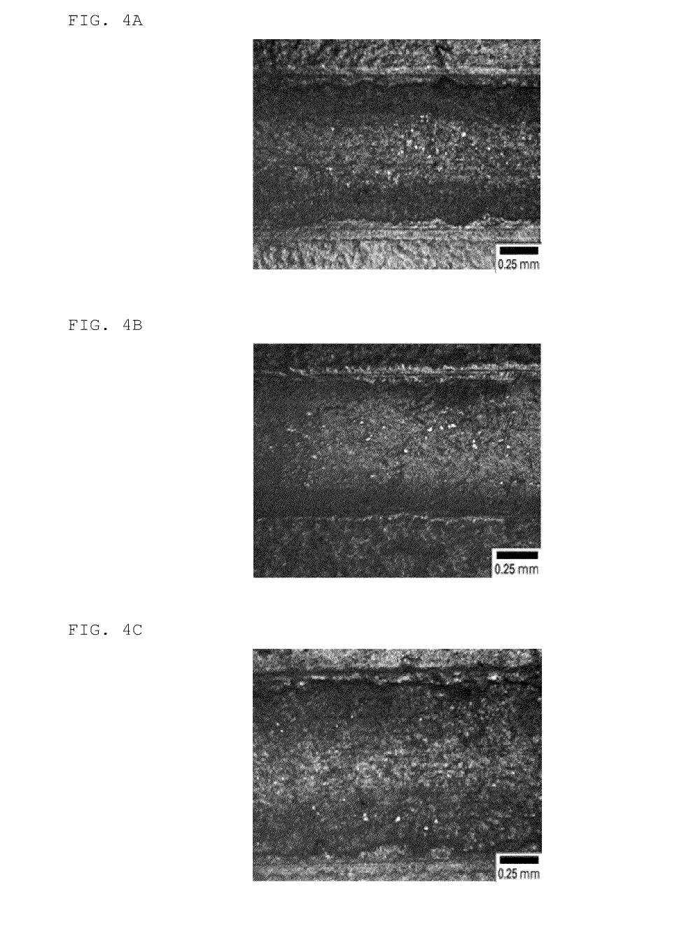

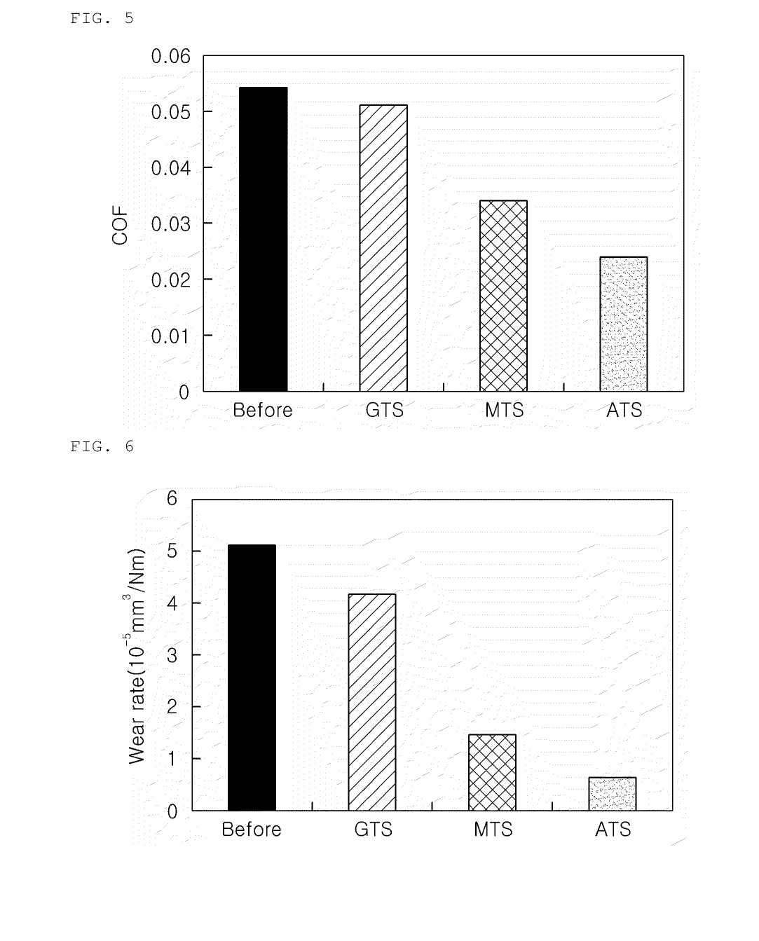

According to other further embodiments of the invention and as shown in FIG. 4, FIGS. 4A to 4C are optical microscope images showing the surfaces of the test samples after the wear test. Preferably, the commercially available PTFE coating solution had the greatest width of the wear track (FIG. 4C), and the PTFE coating agents of Example 1 and Comparative Example had similar widths of the wear track (FIGS. 4A and 4B). In other related embodiments, in the case of Example 1 (FIG. 4A), the depth of the wear track was more shallow, compared to the case of Comparative Example 1 (FIG. 4B).

According to other further embodiments of the invention and as shown in FIG. 5, FIG. 5 shows results of measuring the COF in the wear test. According to other embodiments, for example as shown in FIG. 5, compared to the case not subjected to silane treatment (represented by “before”), the case of Comparative Example 1 subjected to GTS treatment had the COF suitably decreased only by 7%, whereas the case of Example 1 subjected to ATS treatment had the COF suitably decreased by 55% or more and the case of Example 2 subjected to MTS treatment had the COF suitably decreased by 33% or more.

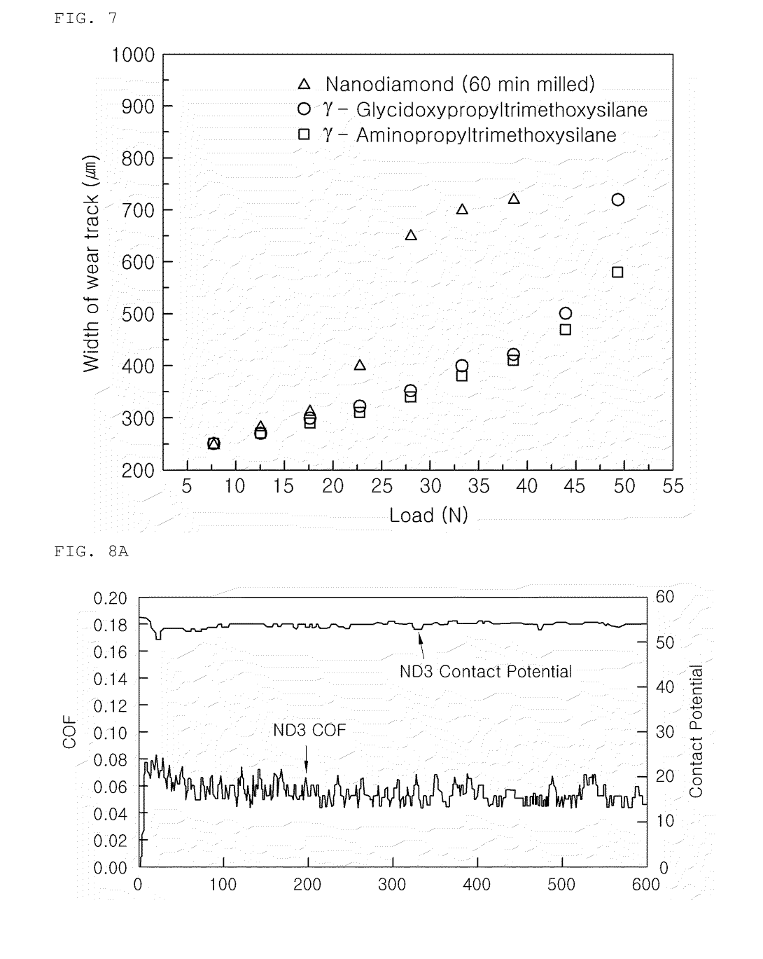

According to other further embodiments of the invention and as shown in FIG. 6, FIG. 6 shows results of measuring the specific wear rate in the wear test. Preferably, as shown in FIG. 6, compared to the case not subjected to silane treatment (represented by “before”), the case of Comparative Example 1 subjected to GTS treatment had the specific wear rate decreased by about 20%, whereas the case of Example 1 subjected to ATS treatment had the specific wear rate decreased by 90% or more and the case of Example 2 subjected to MTS treatment had the specific wear rate decreased by 70% or more. Preferably, in the case where the nanodiamond particles were treated with silane having an amino functional group or a mercapto functional group, low friction and wear resistance could be confirmed to be remarkably improved.

In further preferred embodiments, the test samples were coated with the PTFE coating agent using γ-ATS as the silane coupling agent, the PTFE coating agent using γ-GTS, and the bead-milled nanodiamond dispersion solution without silane treatment were subjected to a wear test under the same conditions as in the above wear test, with the exception that the wear test was suitably performed for 10 min each while stepwisely changing the load from 7.7 N to 49.3 N at intervals of about 5 N, after which the width of the wear track was measured using an optical microscope. Preferably, the results are shown in FIG. 7. According to certain preferred embodiments, FIG. 7 is a graph showing changes in the width of the wear track depending on the load. For example, as shown in FIG. 7, the silane-treated cases had the maximum load bearing increased by about 100% or more compared to that of the case not subjected to silane treatment. Preferably, the ATS-treated PTFE coating agent had the load bearing increased by at least 20% at 50 N or more compared to that of the GTS-treated PTFE coating agent.

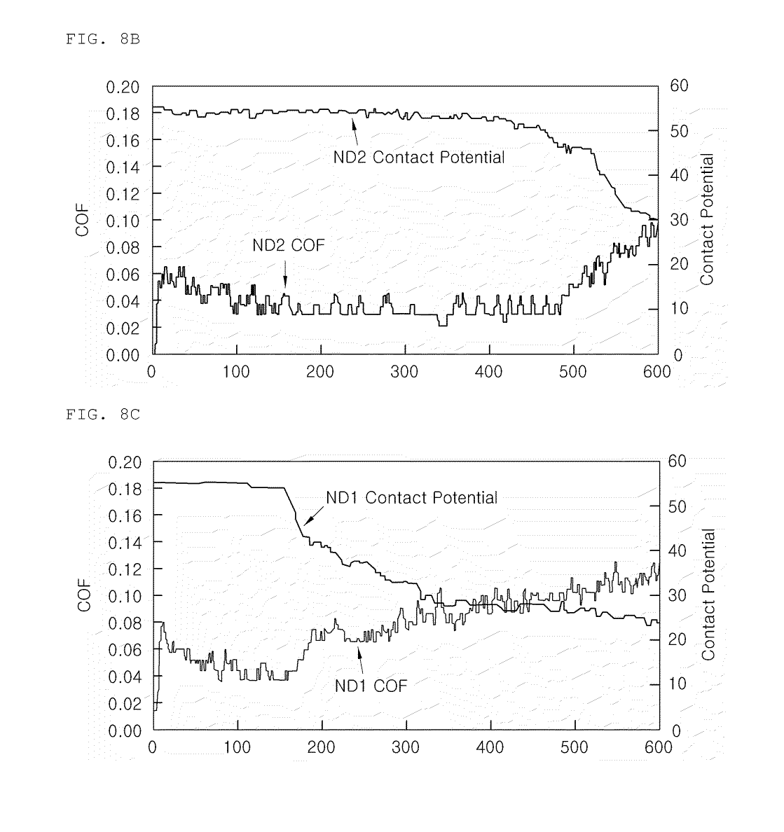

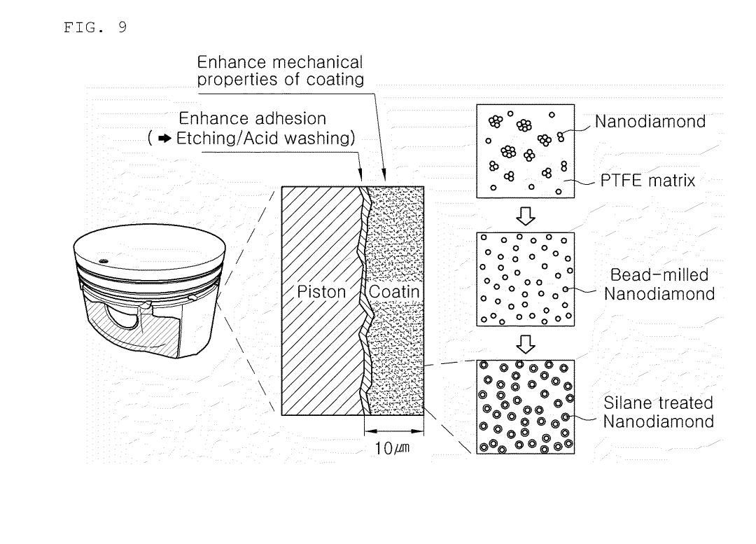

According to other further embodiments of the invention and as shown in FIG. 8, FIGS. 8A to 8C show results of measuring the range where contact resistance is reduced due to generation of metal to metal contact while wearing the PTFE coating which is a nonconductor over time, in an experimental procedure similar to the above wear test. Preferably, as shown in FIG. 8A, in the case of the ATS-treated PTFE coating agent, contact resistance and the COF were not changed even up to 600 sec. According to other embodiments, for example as shown in FIG. 8B, in the case of the MTS-treated PTFE coating agent, contact resistance and the COF were changed after about 500 sec. According to other embodiments, for example as shown in FIG. 8C, in the case of the GTS-treated PTFE coating agent, contact resistance was considerably decreased and the COF was increased after about 150 sec. Preferably, in this experiment, the coating agents were spray coated.

According to other further embodiments of the invention and as shown in FIG. 9, FIG. 9 schematically shows the PTFE coating using the PTFE coating agent that preferably includes a nanodiamond according to preferred embodiments of the present invention. Preferably, the silane coupling agent firmly adheres to the surface of the nanodiamond particles dispersed through bead milling, and a strong bond between the nanodiamond particles and the PTFE is formed by the silane coupling agent. In further preferred embodiments, the force of adhesion between the PTFE coating and the skirt is suitably enhanced through etching of the piston skirt before coating using the PTFE coating agent.

As described herein, in preferred embodiments, the present invention provides a PTFE coating agent, a method of preparing the same and a method of using the same. According to certain preferred embodiments of the present invention, the PTFE coating agent has high dispersibility of nanodiamond powder and enhanced bondability between nanodiamond particles and PTFE, thus exhibiting suitably excellent low friction and high wear resistance.

In other preferred embodiments of the present invention as described herein, vehicle parts coated with the PTFE coating agent can suitably exhibit excellent low friction and high wear resistance, and thus the survival term of the corresponding parts can be suitably prolonged and fuel conversion efficiency is suitably improved. Preferably, the PTFE coating agent according to the present invention can be applied to vehicle parts used under severe friction conditions, such as piston skirts or bearings of engines.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A polytetrafluoroethylene coating agent, comprising:
nanodiamond particles;
a polar organic solvent in which the nanodiamond particles are dispersed;
polytetrafluoroethylene mixed with the polar organic solvent in which the nanodiamond particles are dispersed; and
a silane coupling agent having an inorganic functional group coupled with the polytetrafluoroethylene and an organic functional group coupled with the nanodiamond particles, so as to form a bond between the nanodiamond particles and the polytetrafluoroethylene, in which the organic functional group has at least one selected from among a mercapto group and an amino group.

2. A method of preparing a polytetrafluoroethylene coating agent, comprising:
dispersing nanodiamond powder in a polar organic solvent, thus obtaining a dispersion solution;
mixing the dispersion solution with a silane coupling agent having at least one organic functional group selected from among a mercapto group and an amino group, thus obtaining a silane-treated solution; and
mixing the silane-treated solution with an oily polytetrafluoroethylene coating solution.

3. The method as set forth in claim 2, wherein the polar organic solvent comprises N-methylpyrrolidone.

4. The method as set forth in claim 2, wherein, in dispersing the nanodiamond powder, the nanodiamond powder is mixed with the polar organic solvent and milled using beads having a diameter of 0.1˜0.3 mm.

5. The method as set forth in claim 4, wherein, in dispersing the nanodiamond powder, the nanodiamond powder is dispersed in an amount of 5˜15 parts by weight based on 100 parts by weight of the polar organic solvent.

6. The method as set forth in claim 2, wherein, in mixing the dispersion solution, the silane coupling agent is mixed in an amount of 0.8˜1.2 parts by weight based on 100 parts by weight of the nanodiamond powder.

7. The method as set forth in claim 2, wherein, in mixing the dispersion solution, the dispersion solution and the silane coupling agent are stirred at 60˜70° C. for 5˜7 hours.

8. The method of using the polytetrafluoroethylene coating agent of claim 1, further comprising:
roughening a surface of a part;
applying the polytetrafluoroethylene coating agent on the surface of the part; and
subjecting the polytetrafluoroethylene coating agent applied on the surface of the part to natural drying or hot air drying and then to thermal treatment at 200˜220° C. for 10˜20 min.

9. The method as set forth in claim 8, wherein the polytetrafluoroethylene coating agent has a viscosity of 25,000˜35,000 cps so as to be screen printed on the surface of the part, and the surface of the part is subjected to alkali etching before screen printing.

10. The method as set forth in claim 8, wherein the polytetrafluoroethylene coating agent has a viscosity of 50˜100 cps so as to be spray coated on the surface of the part, and the surface of the part is subjected to sand blasting before spray coating.

11. A polytetrafluoroethylene coating agent, comprising:
nanodiamond particles;
a polar organic solvent;
polytetrafluoroethylene; and
a silane coupling agent.

12. The polytetrafluoroethylene coating agent of claim 11, wherein the nanodiamond particles are dispersed in the polar organic solvent.

13. The polytetrafluoroethylene coating agent of claim 11, wherein the polytetrafluoroethylene is mixed with the polar organic solvent in which the nanodiamond particles are dispersed.

14. The polytetrafluoroethylene coating agent of claim 11, wherein the silane coupling agent has an inorganic functional group coupled with the polytetrafluoroethylene and an organic functional group coupled with the nanodiamond particles, so as to form a bond between the nanodiamond particles and the polytetrafluoroethylene.

15. The polytetrafluoroethylene coating agent of claim 14, wherein the organic functional group has at least one group selected from a mercapto group or an amino group.

16. A method of preparing a polytetrafluoroethylene coating agent, comprising:
dispersing nanodiamond powder in a polar organic solvent, thus obtaining a dispersion solution;
mixing the dispersion solution with a silane coupling agent, thus obtaining a silane-treated solution; and
mixing the silane-treated solution with an oily polytetrafluoroethylene coating solution.

17. The method of preparing a polytetrafluoroethylene coating agent of claim 16, wherein the silane coupling agent has at least one organic functional group selected from a mercapto group and an amino group.
